(19) United States
(12) Patent Application Publication
(10) Pub. No.: US 2022/0168931 A1
(43) Pub. Date: Jun. 2, 2022

(54) FIBER-REINFORCED RESIN COMPOSITE AND METHOD FOR PRODUCING FIBER-REINFORCED RESIN COMPOSITE

(71) Applicant: KURASHIKI BOSEKI KABUSHIKI KAISHA, Okayama (JP)

(72) Inventors: Tadaharu TANAKA, Osaka-shi, Osaka (JP); Yoichi HIRAISHI, Osaka (JP); Takashi NAKAMURA, Osaka-shi, Osaka (JP); Yuta NAKAME, Osaka-shi, Osaka (JP); Yuki KOMAI, Osaka-shi, Osaka (JP)

(73) Assignee: KURASHIKI BOSEKI KABUSHIKI KAISHA, Okayama (JP)

(21) Appl. No.: 17/442,144

(22) PCT Filed: Mar. 11, 2020
(86) PCT No.: PCT/JP2020/010531

§ 371 Date: Sep. 23, 2021

(30) Foreign Application Priority Data
Mar. 27, 2019 (JP) 2019-061684

(51) Int. Cl. B29C 44/56; C08J 5/24; B29C 70/20; B29C 44/12; B29C 70/78; C08J 9/42

(52) U.S. Cl. CPC B29C 44/569; C08J 5/243; B29C 70/20; B29K 2101/12; B29C 70/78; C08J 9/42; C08J 2375/04; B29C 44/12

(57) ABSTRACT

A fiber-reinforced resin composite having high peeling strength between a fiber-reinforced resin and a resin foam. The fiber-reinforced resin composite (10) is a fiber-reinforced resin composite (10) including a skin (11) and a resin foam (12), the resin foam including a foamed resin (16), the skin including a fiber sheet (14), a thermoplastic matrix resin (15), and the foamed resin (16) that is continuous from the resin foam and is impregnated into the skin.

### TECHNICAL FIELD

The present invention relates to a composite in which a fiber-reinforced resin is integrated with a resin foam.

### BACKGROUND ART

A fiber-reinforced resin (FRP) obtained by reinforcing a resin with carbon fiber or the like is known as a lightweight material having high mechanical strength. In general, FRP including a thermosetting resin as a matrix resin often has excellent specific strength, and FRP including a thermoplastic resin as a matrix resin often has excellent toughness and impact resistance. Recently, the latter has been actively developed for high toughness. FRP including a thermoplastic resin as a matrix resin may be referred to particularly as a fiber-reinforced thermoplastic resin (FRTP) in distinction from which including a thermosetting resin.

In addition, a composite in which a fiber-reinforced resin excellent in strength is integrated with a resin foam having a lighter weight has been used for various applications, where the fiber-reinforced resin is used as a skin, and the resin foam is used as a core material. However, such a composite has a problem in adhesiveness between the fiber-reinforced resin and the resin foam, and may be delaminated at an interface between the fiber-reinforced resin and the resin foam.

Regarding integration of a fiber-reinforced resin with a resin foam, Patent Literature 1 describes a resin composite obtained by sandwiching a foam sheet of polyamide 6 or the like between prepregs obtained by impregnating a twill woven fabric or the like including carbon fiber with an uncured epoxy resin, a thermoplastic polyamide 6 resin, or the like, and performing thermocompression bonding. Patent Literature 2 describes a resin composite obtained by sandwiching a foamed sheet of an acrylic resin or the like between prepregs obtained by impregnating a twill woven fabric or the like including carbon fiber with an uncured epoxy resin, and performing thermocompression bonding. Patent Literature 3 describes a method for producing a fiber-reinforced resin sandwich panel by sandwiching a polypropylene foam between prepregs obtained by impregnating unidirectionally aligned carbon fiber with an epoxy resin, and performing thermocompression bonding. In any of Patent Literatures 1 to 3, a thermoplastic resin or a thermosetting resin can be used, and preferably a thermosetting resin is used as a matrix resin. In all examples of Patent Literatures 2 and 3, a thermosetting resin is used as a matrix resin.

### CITATION LIST

### Patent Literature

Patent Literature 1: JPWO 2016-52645 A1

Patent Literature 2: JP 2014-208418 A

Patent Literature 3: JP 2012-76464 A

### SUMMARY OF INVENTION

### Technical Problem

In the composites described in Patent Literatures 1 to 3, the peeling strength between the fiber-reinforced resin and the resin foam is considered to be improved by thermocompression bonding of the prepreg and the resin foam. However, as long as the molded resin foam is used as a starting material, a clear interface remains between the fiber-reinforced resin and the resin foam, and there is a concern over peeling strength.

In addition, when a thermoplastic resin is adopted for a matrix for the fiber-reinforced resin, the prepreg is hard, so that it is difficult to keep the prepreg in a deformed shape, and therefore it is difficult to form a composite having a curved surface.

The present invention has been made in view of the above-described problems, and an object of the present invention is to provide a fiber-reinforced resin composite having high peeling strength between a fiber-reinforced resin and a resin foam.

### Solution to Problem

The fiber-reinforced resin composite of the present invention is a fiber-reinforced resin composite including a skin and a resin foam, the resin foam including a foamed resin, the skin including a fiber sheet, a thermoplastic matrix resin, and the foamed resin that is continuous from the resin foam and is impregnated into the skin. By this configuration, the skin is firmly integrated with the resin foam, so that high peeling strength is obtained between the skin and the resin foam.

Preferably, the fiber sheet is a sheet or a woven fabric in which continuous fiber is aligned in one direction. This configuration facilitates production of a fiber-reinforced resin composite.

Preferably, the fiber sheet includes carbon fiber. This configuration provides lighter weight and higher strength.

Preferably, the matrix resin is a resin selected from the group consisting of a phenoxy resin, polyamide 6, polyamide 12, polypropylene and polycarbonate.

Preferably, the foamed resin is a urethane resin, and the resin foam is a rigid urethane foam. This configuration expands the degree of freedom in design regarding the hardness, resilience and the like of the resin foam.

Another fiber-reinforced resin composite of the present invention is a fiber-reinforced resin composite in which a substrate obtained by partially impregnating a fiber sheet including continuous fiber with a thermoplastic matrix resin is integrated with a resin foam including a foamed resin. Here, the substrate obtained by impregnating a fiber sheet with a thermoplastic matrix resin is one in which voids are left in the fiber sheet rather than impregnating the entire fiber sheet with the matrix resin. By this configuration, a skin portion including the fiber sheet is firmly integrated with the resin foam, so that high peeling strength is obtained between the skin and the resin foam.

Still another fiber-reinforced resin composite of the present invention is a fiber-reinforced resin composite in which a substrate obtained by welding a thermoplastic matrix resin to a surface of a fiber sheet including continuous fiber is integrated with a resin foam including a foamed resin. Here, the substrate obtained by welding a thermoplastic matrix resin to a surface of a fiber sheet is one in which the matrix resin does not penetrate between fibers forming the fiber sheet, and remains on the outer surface of the fiber sheet. Owing to this configuration, a skin portion including the fiber sheet is firmly integrated with the resin foam, so that high peeling strength is obtained between the skin and the resin foam.

The method for producing a fiber-reinforced resin composite according to the present invention includes the steps of: preparing a substrate in which a fiber sheet is partially impregnated with a thermoplastic matrix resin or a substrate in which a thermoplastic matrix resin is welded to a surface of the fiber sheet; supplying a raw material composition of a foamed resin to one surface of the substrate; and foaming the raw material composition to form a resin foam including the foamed resin, and simultaneously impregnating a part of the fiber sheet with the foamed resin to integrate the resin foam with the substrate.

By this method, the substrate is firmly integrated with the resin foam, so that high peeling strength is obtained between the skin portion including the fiber sheet and the resin foam.

In the above-described production method, the step of supplying the raw material composition is preferably a step of disposing the substrate on a cavity surface of a mold and putting the raw material composition into the cavity of the mold. In this way, a flat plate-shaped fiber-reinforced resin composite can be produced, and when the cavity surface of the mold is formed into a curved surface, a flat plate-shaped fiber-reinforced resin composite having a curved surface can be produced.

Alternatively, in the above-described production method, the step of supplying the raw material composition is preferably a step of putting the raw material composition between a first conveyor belt and a second conveyor belt of a double-belt molding machine while supplying the substrate along the first conveyor belt and/or the second conveyor belt. In this way, a flat plate-shaped composite can be efficiently produced.

### Advantageous Effects of Invention

In any of the fiber-reinforced resin composites of the present invention, there is no clear interface between a skin including a fiber sheet and a resin foam, and a foamed resin is continuous from the resin foam and enters the fiber sheet. By an anchor effect of the foamed resin, a skin is firmly integrated with the resin foam, so that high peeling strength is obtained between the skin and the resin foam.

According to the method for producing a fiber-reinforced resin composite of the present invention, a substrate in which a fiber sheet is partially impregnated with a thermoplastic matrix resin or a substrate in which a thermoplastic matrix resin is welded to a surface of the fiber sheet is used, and therefore in the step of foaming a raw material composition, the foamed resin forms a resin foam, and simultaneously enters the fiber sheet. As a result, the skin portion including the fiber sheet, the substrate and the resin foam are firmly integrated by the anchor effect of the foamed resin, so that a fiber-reinforced resin composite having high peeling strength between a skin portion including a fiber sheet and a resin foam can be obtained.

### BRIEF DESCRIPTION OF DRAWINGS

FIG. 1 is a diagram showing a cross-sectional structure of a fiber-reinforced resin composite of one embodiment.

FIG. 2 is a diagram for illustrating a double-belt molding method for the fiber-reinforced resin composite of one embodiment.

### DESCRIPTION OF EMBODIMENT

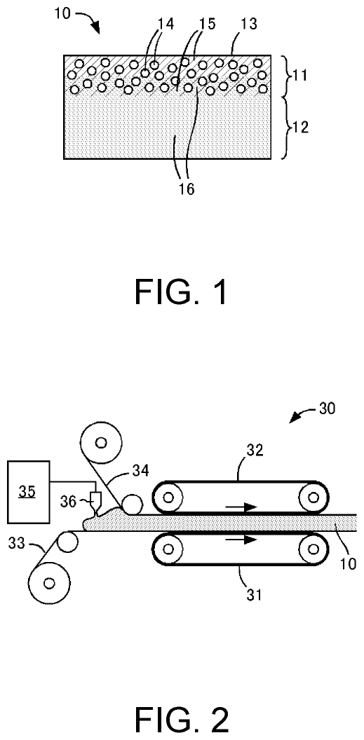

Referring to FIG. 1, a fiber-reinforced resin composite 10 of the present embodiment includes a skin 11 and a resin foam 12.

The resin foam 12 is composed of a foamed resin 16. The thickness of the resin foam 12 may be determined according to required performance, and is not particularly limited. The thickness of the resin foam 12 is typically 5 to 200 mm.

As the foamed resin 16 forming the resin foam 12, for example, a urethane resin, an ABS resin, an olefin-based resin, a polyester-based resin, a polystyrene resin or an acrylic resin can be used. The foamed resin 16 is preferably a urethane resin. This is because a urethane resin foam allows properties such as hardness, elasticity, resilience and sound absorbency to be widely adjusted by changing the combination of raw material components, so that the degree of freedom in product design of the fiber-reinforced resin composite 10 increases. The resin foam 12 is preferably a rigid urethane foam having a closed-cell structure. By this, the skin 11 excellent in hardness can be obtained. The closed cell ratio of the rigid urethane foam is preferably 80% or more, more preferably 90% or more. In addition, the expansion ratio of the resin foam 12 is preferably 25 or more.

The skin 11 is a fiber-reinforced resin including a fiber sheet 14, a matrix resin 15 which is a thermoplastic resin, and a foamed resin 16. The skin 11 forms one surface 13 of the fiber-reinforced resin composite 10. A part or the whole of the skin 11 including the vicinity of the interface with the resin foam 12 is impregnated with the foamed resin 16. When the entire skin 11 is impregnated with the foamed resin 16, the foamed resin may reach the surface 13. The foamed resin 16 is continuous from the resin foam 12 and is impregnated into the fiber sheet 14. In other words, the portion with the foamed resin 16 impregnated into the fiber sheet 14 and the resin foam 12 are formed simultaneously as one united body.

The skin 11 may be formed on one surface of the fiber-reinforced resin composite 10 as shown in FIG. 1, or may be formed on both surfaces of the fiber-reinforced resin composite 10.

The thickness of the skin 11 may be determined according to required performance, and is not particularly limited. The thickness of the skin 11 is the thickness of a portion where the matrix resin 15 is present. The thickness of the skin 11 is typically 0.05 to 1 mm.

The fiber sheet 14 contained in the skin 11 includes, for example, carbon fiber, glass fiber, ceramic fiber such as alumina fiber, or metal fiber such as steel fiber. Preferably, the fiber sheet 14 includes carbon fiber. This is because lighter weight and higher strength can be obtained.

Preferably, the fiber sheet 14 is composed of continuous fiber. This is because the strength of the skin 11 can be increased. When the fiber sheet 14 is composed of continuous fiber, the fiber sheet 14 may be a nonwoven fabric, and is preferably a sheet or a woven fabric in which continuous fiber is unidirectionally aligned. By this, the fiber sheet 14 is easily impregnated with the foamed resin 16 in production of the fiber-reinforced resin composite 10. When the fiber sheet 14 is a sheet in which continuous fiber is unidirectionally aligned, a plurality of fiber sheets may be overlapped so that the length directions of the fiber intersect one another.

The matrix resin 15 of the skin 11 is a thermoplastic resin. As the matrix resin 15, one of thermoplastic resins such as olefin resins, polyester resins, polyamide resins, acrylic resins, phenoxy resins, sulfide resins, polycarbonate resins and polypropylene-based resins can be used, or two or more of these thermoplastic resins can be mixed and used. The matrix resin 15 is preferably a resin selected from the group consisting of a phenoxy resin, polyamide 6, polyamide 12, polypropylene and polycarbonate.

The skin 11 includes the fiber sheet 14, the matrix resin 15 and the foamed resin 16. Gaps between fibers of the fiber sheet 14 are filled with the matrix resin 15 and the foamed resin 16. The ratio (fiber volume content ratio) of the fiber sheet 14 to the skin 11, i.e. fiber/(fiber+matrix resin+foamed resin), is preferably 15 to 45 vol %, more preferably 20 to 40 vol %.

In the skin 11, the thickness of a portion in which the fiber sheet 14 is impregnated with the foamed resin 16 (hereinafter, referred to as a “penetration thickness of foamed resin”) can be defined as the thickness of a portion in which the ratio of the foamed resin 16 to resin components present between the fibers, i.e. foamed resin/(matrix resin+foamed resin) is 40 vol % or more. The penetration thickness of foamed resin is preferably 0.1 mm or more, or equal to or more than half the thickness of the fiber sheet 14. This is because the peeling strength between the skin 11 and the resin foam 12 can be enhanced as the penetration thickness of the foamed resin increases. On the other hand, the penetration thickness of the foamed resin is preferably 1.0 mm or less. This is because peeling strength cannot be further improved even when the penetration thickness of the foamed resin is further increased.

The composition ratio of the components in the skin 11 and the penetration thickness of the foamed resin 16 vary depending on a substrate (semi-preg) used for production. The fiber-reinforced resin composite 10 of the present embodiment can be a fiber-reinforced resin composite in which a substrate obtained by partially impregnating the fiber sheet 14 including continuous fiber with the thermoplastic matrix resin 15 is integrated with the resin foam 12 including the foamed resin 16. Alternatively, the fiber-reinforced resin composite 10 can be a fiber-reinforced resin composite in which a substrate obtained by welding the thermoplastic matrix resin 15 to a surface of the fiber sheet 14 including continuous fiber is integrated with the resin foam 12 including the foamed resin 16. Details of the substrate will be described later.

A method for producing the fiber-reinforced resin composite 10 according to the present embodiment will now be described.

The production method of the present embodiment includes the steps of: preparing a substrate including the fiber sheet 14 and the thermoplastic matrix resin 15; supplying a raw material composition of the foamed resin 16 to one surface of the substrate; and foaming the raw material composition.

As the substrate including the fiber sheet 14 and the thermoplastic matrix resin 15, for example, a substrate obtained by partially impregnating the fiber sheet 14 with the thermoplastic matrix resin 15 can be used. The substrate in which a fiber sheet is partially impregnated with a matrix resin is a substrate in which voids are left in the fiber sheet 14 rather than impregnating the entire fiber sheet 14 with the matrix resin 15. Such a substrate is called a semi-preg against a prepreg in which a fiber sheet is completely impregnated with a matrix resin. The substrate in which a fiber sheet is partially impregnated with a matrix resin is hereinafter referred to as a “partially impregnated semi-preg”.

The partially impregnated semi-preg can be produced by attaching powder of the matrix resin 15 to one surface or both surfaces of the fiber sheet 14, and softening or melting the powder by heating to partially impregnate the fiber sheet 14 with the powder. Alternatively, the partially impregnated semi-preg may be produced by attaching a film of the matrix resin 15 to one surface or both surfaces of the fiber sheet 14, and softening or melting the film by heating to partially impregnate the fiber sheet with the film. Here, voids are left in the fiber sheet 14 rather than impregnating the entire fiber sheet 14 with the matrix resin 15. The voids left between the fibers enable impregnation of the foamed resin 16 into the fiber sheet 14 in the step of foaming the foamed resin 16. The volume ratio of the fiber sheet 14 and the matrix resin 15 is preferably 40:60 to 60:40.

In addition, as the substrate including the fiber sheet 14 and the thermoplastic matrix resin 15, a substrate may be obtained by welding the thermoplastic matrix resin 15 to one surface or both surfaces of the fiber sheet 14. The substrate obtained by welding a thermoplastic matrix resin to a surface of a fiber sheet is one in which the matrix resin 15 does not penetrate between fibers forming the fiber sheet 14, and remains on the outer surface of the fiber sheet 14. Therefore, voids are completely left in the fiber sheet 14. Such a substrate is also called a semi-preg. The substrate obtained by welding a matrix resin to a surface of a fiber sheet is hereinafter referred to as a “surface-welded semi-preg”.

The surface-welded semi-preg can be produced in the same manner as in the case of the partially impregnated semi-preg. However, the matrix resin 15 is welded to the surface of the fiber sheet 14 with the matrix resin 15 softened at a lower temperature so as not to enter between fibers forming the fiber sheet 14. The volume ratio of the fiber sheet 14 and the matrix resin 15 is preferably 40:60 to 60:40.

Among the various semi-pregs described above, those having openings of a matrix resin formed on the surface and having continuous voids extending through the semi-preg in a thickness direction are preferably used. Specifically, it is preferable to use a semi-preg produced by attaching powder of a matrix resin to a surface of the fiber sheet 14. This is because in the step of foaming the foamed resin 16, gas passes through the semi-preg, so that the foamed resin 16 is easily impregnated into the fiber sheet 14. In addition, comparison of the partially impregnated semi-preg with the surface-welded semi-preg shows that use of the surface-welded semi-preg is preferable. This is because there are many voids inside the fiber sheet 14, so that the foamed resin 16 is easily impregnated into the fiber sheet 14 in the step of foaming the foamed resin 16.

As described above, it is preferable that a sheet or a woven fabric in which continuous fiber is unidirectionally aligned as the fiber sheet 14 is used. A sheet in which continuous fiber is unidirectionally aligned is obtained by opening a unidirectionally continuous fiber bundle. In a surface-welded semi-preg including a sheet in which continuous fiber is unidirectionally aligned, the fiber sheet 14 is likely to come apart, and thus bridge fiber may be disposed on the surface of the fiber sheet 14 and in a direction crossing the fiber sheet 14. As the bridge fiber, the same fiber as that of the fiber sheet 14 main body can be used. The density of the bridge fiber is preferably 25 to 150 pieces on average per area of 10 mm² of the fiber sheet 14.

As a raw material composition of the foamed resin 16, a known one can be used. For example, when the foamed resin 16 is a urethane resin, a mixed liquid of isocyanate and polyol can be used as the raw material composition. This raw material composition is supplied to one surface of the semi-preg. The resin foam 12 is formed on a side where the raw material composition of the semi-preg is supplied, and the opposite side corresponds to the surface 13 of the fiber-reinforced resin composite 10 which is produced. The surface to which the powder of the matrix resin 15 is attached in production of the semi-preg has a high ratio of the matrix resin 15 to fiber, and therefore when this surface comes to the surface 13 of the fiber-reinforced resin composite 10, the surface 13 can be made denser.

In the step of foaming the raw material composition, the fiber sheets 14 of adjacent semi-pregs are impregnated with foamed resin 16 by a foaming pressure while the resin foam 12 is formed. Gaps between the fibers of the fiber sheet 14 are filled with the matrix resin 15 and the foamed resin 16 to form the hard skin 11. In addition, since the foamed resin 16 is continuous from the resin foam 12 and is impregnated into the fiber sheet 14, the skin 11 is firmly integrated with the resin foam 12, so that high peeling strength is obtained between the skin 11 and the resin foam 12.

When the softening temperature of the matrix resin 15 is sufficiently low, the matrix resin 15 is heated to a softening temperature or higher by external heating means, or reaction heat in the case where foaming is an exothermic reaction, so that the matrix resin is softened or melted, and impregnation into the fiber sheet 14 further proceeds. Here, at a surface portion of the semi-preg on a side opposite to the resin foam 12, the fiber sheet 14 is completely impregnated with the matrix resin 15 to obtain the surface 13 composed only of the fiber sheet 14 and the matrix resin 15.

The step of foaming the raw material composition is also a step of integrating the skin 11 of the fiber-reinforced resin with the resin foam 12 to form the entire fiber-reinforced resin composite 10. This step can be carried out by, for example, a molding method or a double-belt molding method.

In the molding method, the foamed resin 16 is foamed in a mold. The semi-preg is fixed along the cavity surface of one or both of the lower mold and the upper mold of the mold. The raw material composition of the foamed resin 16 is put into the cavity of the mold, and the mold is maintained at an appropriate temperature to foam the raw material composition. According to the molding method, the fiber-reinforced resin composite 10 having a curved surface can be produced by forming the cavity surface of the mold into a curved surface.

In the double-belt molding method, the resin is foamed between the pair of conveyor belts. Referring to FIG. 2, a double-belt-type molding machine 30 includes a lower conveyor belt 31 and an upper conveyor belt 32, and surface materials 33 and 34 are supplied along the respective conveyor belts. Here, the semi-preg is supplied as one or both of the surface materials 33 and 34. The raw material composition is discharged from a raw material tank 35 onto the surface material 33 through a mixing/stirring nozzle 36, and thereby put between the lower conveyor belt 31 and the upper conveyor belt 32. The raw material composition is foamed while moving in the right direction in FIG. 2 depending on the movement of the conveyor belts 31 and 32, sandwiched between the conveyor belts 31 and 32, and molded into a composite integrally with the surface materials 33 and 34. By the double-belt molding method, the flat plate-shaped fiber-reinforced resin composite 10 can be efficiently produced.

In the production method of the present embodiment, a semi-preg with a thermoplastic resin as a matrix resin is used as a starting material. Since voids are left in the fiber sheet 14 of the semi-preg, the fiber sheet 14 can be impregnated with the foamed resin 16. In addition, unlike a prepreg in which a fiber sheet is completely impregnated with a thermoplastic resin, a semi-preg has flexibility, and is therefore easily fixed along a curved surface of a mold in a molding method, so that it is easy to produce the fiber-reinforced resin composite 10 having a curved surface.

### EXAMPLES

A fiber-reinforced resin composite of Example 1 was produced by the following method. As a semi-preg, a surface-welded semi-preg obtained by applying powder of a phenoxy resin (Nippon Steel Chemical & Material Co., Ltd., YD-10, Tg: 84° C.) to both surfaces of a sheet (areal weight: 50 g/m²) obtained by opening a continuous fiber bundle in one direction of carbon fiber and performing heating to weld the powder was used. The ratio of the phenoxy resin was 50% in terms of volume ratio when the total of the fiber sheet and the phenoxy resin is 100%. As the foamed resin, a urethane resin was used. A semi-preg was set on the bottom surface of a lower mold having a size of 400 mm in length×400 mm in width×50 mm in cavity thickness, and as a raw material composition of a foamed resin, two liquids of isocyanate (Tosoh Corp., MR-200) and polyol (Asahi Glass Co., Ltd., EL-450 ED: 50%, Sanyo Chemical Industries, Ltd., HS-209: 50%) were mixed, and injected into a mold. A flame retardant, a foaming agent, a foam stabilizer and a catalyst were blended in the polyol. The lid (upper mold) was closed, and foaming was performed for 10 minutes while the temperature of the mold was maintained at 40° C., followed by demolding. The obtained resin foam was a rigid urethane foam having a density of 43 kg/m³, an expansion ratio of 30 times, and a closed-cell structure. In the manner described above, a fiber-reinforced resin composite of Example 1 was obtained. This fiber-reinforced resin composite has a flat plate shape, and is one in which a skin including a fiber sheet and a phenoxy resin is integrated with one surface of a rigid urethane foam.

A fiber-reinforced resin composite of Comparative Example 1 was produced by the following method. The semi-preg used in Example 1 was heated to prepare a prepreg in which a fiber sheet was completely impregnated with a phenoxy resin. Subsequently, using this prepreg, a fiber-reinforced resin composite of Comparative Example 1 was prepared in the same manner as in Example 1.

Each of the fiber-reinforced resin composites of Example 1 and Comparative Example 1 had a hard surface having high flexural rigidity. In the fiber-reinforced resin composite of Example 1, the urethane resin was observed to reach the surface by passing through the fiber sheet.

For the fiber-reinforced resin composites of Example 1 and Comparative Example 1, the peeling strength between the skin and the resin foam was measured in accordance with JIS K 6854-1 for adhesives. Ten samples having a width of 25 mm were cut out from the fiber-reinforced resin composite, and a 90 degree-peeling test was conducted at a test speed of 100 mm/min. The results are shown in Table 1. In Table 1, the maximum projection point means the maximum value of the peaks of the peeling force during the test, the average of projection points means the average value of the above-mentioned peaks, and the average means the average value of the peeling forces during the test.

TABLE 1

| | Peeling force (N/25 mm) | | | | Peeling force (N/25 mm) | | |
|---|---|---|---|---|---|---|---|
| | Maximum | Average of | | Comparative | Maximum | Average of | |
| Example 1 | projection point | projection points | Average | Example 1 | projection point | projection points | Average |
| 1 | 9.48 | 6.53 | 5.72 | 1 | 7.96 | 4.36 | 3.36 |
| 2 | 8.33 | 5.70 | 4.53 | 2 | 6.26 | 3.39 | 2.64 |
| 3 | 9.73 | 6.68 | 5.53 | 3 | 6.54 | 3.90 | 2.88 |
| 4 | 7.53 | 4.85 | 3.03 | 4 | 5.80 | 3.15 | 2.44 |
| 5 | 10.00 | 5.54 | 3.61 | 5 | 5.60 | 3.15 | 2.66 |
| 6 | 9.78 | 5.16 | 3.33 | 6 | 7.50 | 3.75 | 2.87 |
| 7 | 10.86 | 5.52 | 3.45 | 7 | 7.42 | 3.33 | 2.68 |
| 8 | 11.54 | 5.69 | 4.55 | 8 | 6.90 | 3.45 | 2.92 |
| 9 | 9.40 | 6.63 | 5.76 | 9 | 6.05 | 4.22 | 2.99 |
| 10 | 9.52 | 6.09 | 5.32 | 10 | 7.27 | 4.61 | 3.81 |
| Average | 9.62 | 5.84 | 4.48 | Average | 6.73 | 3.73 | 2.92 |
| Standard | 1.13 | 0.63 | 1.07 | Standard | 0.80 | 0.52 | 0.40 |
| deviation | | | | deviation | | | |

Table 1 reveals that Example 1 had higher peeling strength than Comparative Example 1. For the breakage state, all of the ten measurements in Example 1 showed aggregate fracture of resin foam matrix, and all of the ten measurements in Comparative Example 1 showed interface peeling between the skin and the resin foam.

Next, a fiber-reinforced resin composite of Example 2 was produced by the following method. The same semi-preg, foamed resin and raw material composition as in Example 1 were used. A semi-preg was fixed to the cavity surfaces of the upper mold and the lower mold formed into a curved surface, and a urethane resin was foamed in the same manner as in Example 1. In this way, the fiber-reinforced resin composite of Example 2, which had a corrugated plate shape and in which a skin including a fiber sheet and a phenoxy resin was integrated with both surfaces of a rigid urethane foam, was obtained.

It was confirmed that this method enables production of a composite having a curved surface. In the fiber-reinforced resin composite of Example 2, the urethane resin was observed to reach the surface by passing through the fiber sheet as in Example 1.

### REFERENCE SIGNS LIST

10 fiber-reinforced resin composite

11 skin (fiber-reinforced resin)

12 resin foam

13 surface

14 fiber sheet

15 matrix resin

16 foamed resin

30 conveyor belt-type molding machine

31 lower conveyor belt (first conveyor belt)

32 upper conveyor belt (second conveyor belt)

33, 34 surface material

35 raw material tank

36 mixing/stirring nozzle

1. A fiber-reinforced resin composite comprising a skin and a resin foam,
the resin foam including a foamed resin,
the skin including a fiber sheet, a thermoplastic matrix resin, and the foamed resin that is continuous from the resin foam and is impregnated into the skin.

2. The fiber-reinforced resin composite according to claim 1, wherein the fiber sheet is a sheet or a woven fabric in which continuous fiber is aligned in one direction.

3. The fiber-reinforced resin composite according to claim 1, wherein the fiber sheet includes carbon fiber.

4. The fiber-reinforced resin composite according to claim 1, wherein the matrix resin is a resin selected from the group consisting of a phenoxy resin, polyamide 6, polyamide 12, polypropylene and polycarbonate.

5. The fiber-reinforced resin composite according to claim 1, wherein the foamed resin is a urethane resin, and the resin foam is a rigid urethane foam.

6. (canceled)

7. A fiber-reinforced resin composite in which a substrate obtained by welding a thermoplastic matrix resin to a surface of a fiber sheet including continuous fiber is integrated with a resin foam including a foamed resin.

8. A method for producing a fiber-reinforced resin composite, the method comprising the steps of: preparing a substrate in which a fiber sheet is partially impregnated with a thermoplastic matrix resin or a substrate in which a thermoplastic matrix resin is welded to a surface of the fiber sheet; supplying a raw material composition of a foamed resin to one surface of the substrate; and foaming the raw material composition to form a resin foam including the foamed resin, and simultaneously impregnating a part of the fiber sheet with the foamed resin to integrate the resin foam with the substrate.

9. The method for producing a fiber-reinforced resin composite according to claim 8, wherein the substrate is a substrate obtained by partially impregnating the fiber sheet with the thermoplastic matrix resin.

10. The method for producing a fiber-reinforced resin composite according to claim 8, wherein the substrate is a substrate obtained by welding the thermoplastic matrix resin to the surface of the fiber sheet.

11. The method for producing a fiber-reinforced resin composite according to claim 8, wherein the step of supplying the raw material composition is a step of disposing the substrate on a cavity surface of a mold and putting the raw material composition into the cavity of the mold.

12. The method for producing the fiber-reinforced resin composite according to claim 8, wherein the step of supplying the raw material composition is a step of putting the raw material composition between a first conveyor belt and a second conveyor belt of a double-belt molding machine while supplying the substrate along the first conveyor belt and/or the second conveyor belt.
